(19) United States
(12) Patent Application Publication
(10) Pub. No.: US 2025/0361433 A1
(43) Pub. Date: Nov. 27, 2025

(54) MOLTEN SALT DEVICE RESISTANT TO CORROSION

(71) Applicants: COMMISSARIAT A L'ENERGIE ATOMIQUE ET AUX ENERGIES ALTERNATIVES, Paris (FR); ORANO, CHATILLON (FR)

(72) Inventor: Jérôme SERP, SAINT GENIES DE COMOLAS (FR)

(21) Appl. No.: 18/874,824

(22) PCT Filed: Jun. 13, 2023
(86) PCT No.: PCT/FR2023/050851

§ 371 Date: Dec. 13, 2024

(30) Foreign Application Priority Data
Jun. 14, 2022 (FR) FR2205770

(51) Int. Cl. C09K 5/12; F24S 80/20; G01N 27/30; G01N 27/416; G21C 1/02; G21C 3/54

(52) U.S. Cl. CPC C09K 5/12; F24S 80/20; G01N 27/301; G01N 27/4168; G21C 1/02; G21C 3/54

(57) ABSTRACT

A device comprising a component configured to contain or circulate a solution, the component having a wall made of steel or a nickel-based alloy comprising chromium, a solution in contact with the wall and including a mixture of molten chloride salts. The solution also includes Ti2+ ions and Ti3+ ions, the Ti3+/Ti2+ ratio being between 20/80 and 70/30.

### TECHNICAL FIELD

The present invention relates to the general nuclear and concentrated solar field.

The invention relates to a device comprising a component having a wall made of steel or a nickel-based alloy comprising chromium in contact with a solution of molten salts (molten chlorides).

The invention also relates to a method for preparing such a device as well as a method for measuring the potential of a molten salt solution of such a device.

The invention applies to many industrial fields, and particularly for molten-salt nuclear reactors including their primary and secondary circuits or for concentrated solar power plants.

The invention is of particular interest because it makes it possible to considerably reduce the corrosion phenomena occurring at the interface between a wall made of metal alloy and a molten salt solution, even for devices operating at high temperatures (typically greater than 500° C.).

### Prior Art

From an industrial perspective, molten salts can be used for producing metals by electrolysis (Al, Na, Mg, etc.), or as a heat transfer medium for concentrated thermal solar type applications and for nuclear applications, as a fuel or as a heat transfer fluid for example for nuclear reactors and including actinide converters. For example, in the case of solar applications, thanks to the thermal inertia of molten salts, it is possible to retain high temperatures for several hours even after sunset.

For applications at very high temperatures (typically greater than 600° C.), chloride salts (such as KCl, NaCl and MgCl₂) are preferred over nitrate salts which are decomposed at lower temperatures.

However, the high chemical reactivity of these media forms very aggressive conditions favouring corrosion. This phenomenon is all the more accentuated when the temperatures used in the solar and nuclear devices are very high. Thus, the materials in contact with these media are substantially corroded, which poses problems for the operation and longevity of the installations. Furthermore, the dissolution of metal materials also modifies the composition and thermophysical properties of the heat transfer fluid by adding CrCl₂ and FeCl₂ for example.

Although the corrosive aspect of molten chlorides is known, the results of corrosion rates or of material consumption (thickness per unit time) are disparate and reflect different and poorly controlled experimental conditions Nevertheless, corrosion in molten chlorides continues to be the subject of number academic and industrial studies. Several solutions have been envisaged such as for example:
using steels having a good corrosion resistance (nickel-rich steels),
limiting the presence of hydroxide—and oxide-type impurities, of HCl and of Cl₂, which are involved in the oxidation or complexation mechanisms of steel constituents; for example, by using a controlled inerting atmosphere (argon in particular) to reduce corrosion,
modifying the chemical potential of the molten salt solution.

While controlling the chemical potential of the molten salt solution is an effective means for limiting corrosion, its value can be affected by fission and transmutation reactions and by introducing impurities into the system (H₂O, O₂, etc.). This is particularly likely in the case of a nuclear reactor, the presence of EuCl₃ for example has, on account of the high potential of the Eu³⁺/Eu²⁺ pair, an oxidising effect with respect to chromium, to iron, but also to nickel.

The use of a redox buffer has been used historically in molten-salt reactors to control the chemical potential of the fluoride salt and limit corrosion. For example, it has been demonstrated that the U³⁺/U⁴⁺ pair in molten fluorides makes it possible to mitigate corrosion by controlling the proportions of U³⁺ and U⁴⁺ dissolved in the salt (Journal of Nuclear Materials 440 (2013) 243-249). A concentration ratio in the salt U⁴⁺/U³⁺<100 is recommended to limit the corrosion of steels and the intergranular corrosion by tellurium up to 750° C. The adjustment of the oxidation states of uranium can be obtained using a reducing metal, such as uranium or beryllium.

Document US 2017/0294241 A1 also proposes adding uranium to control the redox potential and mitigate corrosion in a molten-salt reactor. Numerous elements capable of acting as a buffer pair are cited without giving precise experimental conditions. This concept has also been applied for NaCl—KCl—MgCl₂ type concentrated solar salts as described in document WO 2019/075177 A1. To limit corrosion, it is possible to add metal magnesium to alkali and alkaline earth chloride salts containing MgCl₂. Adding Mg metal makes it possible to use the Mg²⁺/Mg⁰ electrochemical pair in solution, which from a thermodynamic perspective, is favourable for inhibiting the dissolution of chromium, of iron and of nickel. The use of Mg metal in excess makes it possible to maintain the potential of the solution at a lower potential than that of dissolution of the major constituents of steels.

However, the presence of excess dissolved Mg in the salt can result in the formation of Mg—Ni alloys on the surface of materials such as for example on 316H steel (Corrosion Science 194 (2022) 109914). Furthermore, magnesium metal is a strong reducing agent capable of reducing actinide chlorides to metal actinide. Therefore, this solution seems to be unsuitable for a molten-salt nuclear reactor, because it would result in the formation of metal actinides which would render the combustible salt inhomogeneous. Furthermore, the metal actinides could combine with the metal materials in contact with the molten salt. For example, plutonium results in the formation of defined compounds with iron (Fe₂Pu and Fe₆Pu) that are liquid at low temperatures according to the composition.

In document WO2017/060741 A1, to reduce the corrosion of steels in contact with molten halogen salts (fluorides or chlorides), it is indicated that more reactive sacrificial metals, such as zirconium, vanadium or titanium, can be used. This document is essentially focused on the Pauling scale of metals. This document mentions the following species pairs: ZrF₂ and ZrF₄, TiF₂ and TiF₄, VF₂ and VF₃. However, the existence of ZrF₂ in molten salts has never been demonstrated, nor even that of TiF₂.

Furthermore, this document does not specify the experimental conditions to be implemented. In particular, this document gives no precise indication on the concentrations or on the redox potential to target, on how to find the suitable buffer pair according to the molten salts and to the material to be protected, or even on the method to control and maintain the stability of the species in the molten salt solution.

### DISCLOSURE OF THE INVENTION

An aim of the present invention is to provide a device for limiting corrosion phenomena of metal alloys in contact with molten chlorides.

For this, the present invention proposes a device comprising:
a component configured to contain or circulate a solution, the component having a wall made of steel or of a nickel-based alloy comprising chromium,
a solution, in contact with the wall, comprising a mixture of molten chloride salts, the solution further comprising Ti²⁺ ions and Ti³⁺ ions, the Ti³⁺/Ti²⁺ concentration ratio being between 20/80 and 70/30.

The invention differs fundamentally from the prior art by the use of titanium to reduce the corrosion of metal parts in contact with molten chloride salts.

Titanium is a much less reducing than magnesium and therefore more suitable for an application for a molten-salt reactor (MSR) while being quite negative to prevent the corrosion of metal alloys, for example steel type. Furthermore, titanium is quite transparent to neutrons to limit its transmutation in the reactor.

Furthermore, the control of the concentration of Ti²⁺ ions and of Ti³⁺ ions is essential to be placed in the potential range where effective redox control is performed and therefore to limit or even to prevent the dissolution of metal alloys. Outside this immunity range, elements such as chromium and iron are dissolved in the molten salt solution.

Such a device can be used for concentrated solar type applications or for molten-salt reactor (MSR) applications.

According to one alternative embodiment, the device is a nuclear device and the component is a primary circuit of a nuclear fission reactor or a secondary circuit of a nuclear fission reactor. The primary circuit of a nuclear fission reactor and the secondary circuit of a nuclear fission reactor make it possible to circulate the chloride salt mixture.

The reactor can be a fast-neutron molten-salt reactor.

According to another alternative embodiment, the device is a solar device, for example a concentrated solar power plant, and the component is a fluidic circuit of molten chlorides or a container of molten chlorides.

The solution comprises a mixture of molten chlorides. For example, it can consist of:
a binary mixture or a ternary mixture of alkali and alkaline earth metal chlorides, generally used as a heat transfer fluid, or
a mixture containing one of more actinide chlorides generally used for nuclear applications.

According to a first advantageous embodiment, the mixture of molten chloride salts is a binary or ternary mixture of alkali and alkaline earth metal chlorides. Preferably, the mixture is obtained from molten chlorides chosen from LiCl, NaCl, KCl, MgCl₂, CaCl₂) and BaCl₂. For a binary mixture, it is possible to choose, for example, an NaCl—MgCl₂ mixture or a KCl—MgCl₂ mixture, whereas for a ternary mixture, it is possible to choose, for example, an NaCl—KCl—MgCl₂ mixture. These mixtures form a particularly advantageous heat transfer fluid when the component is a secondary circuit of a nuclear fission reactor, a container or a fluidic circuit of a concentrated solar power plant.

According to a second advantageous embodiment, the mixture of molten chloride salts comprises at least one actinide chloride. By at least is meant that the mixture of molten chlorides comprises one or more actinide chlorides. Actinide chlorides are compounds having the formula AcCl₃ where Ac is an actinide. Preferably, Ac is Pu, Am, U or Cm, more preferably Pu, Am or Cm. More preferably, Pu or Am will be chosen. The actinide chloride(s) will be preferably added to one of the binary mixtures described hereinabove.

In other words, the mixture of molten chloride salts is a binary mixture of alkali and alkaline earth metal chlorides and of one or more actinide chlorides (preferably one or two actinide chlorides). The actinide chlorides are, preferably, chosen from UCl₃, PuCl₃ and AmCl₃, and more preferably from PuCl₃ and AmCl₃.

Preferably, the mixture of molten chloride salts is an NaCl—MgCl₂—PuCl₃ or NaCl—MgCl₂—PuCl₃—AmCl₃ mixture. These mixtures form the fuel of the nuclear reactor. This embodiment is particularly advantageous when the component is a primary circuit of a nuclear fission reactor.

As a chemical analogue of NaCl—MgCl₂—PuCl₃, it is possible to use the mixture NaCl—MgCl₂—CeCl₃.

Advantageously, the solution is at a temperature between 450° C. and 700° C. and preferably between 550° C. and 650° C.

The wall is made of steel or of a nickel-based alloy. Advantageously, the wall is made of a material mechanically resistant to high temperatures. Preferably, the wall is made of stainless steel, for example 316L steel. According to another preferential embodiment, the wall is made of a nickel-based alloy comprising, preferably, at least 40% by mass of nickel. For example, it consists of a nickel-chromium-molybdenum alloy, in particular NiCr22Mo9Nb.

Advantageously, the Ti³⁺/Ti²⁺ ratio is between 30/70 and 50/50.

The device has numerous advantages. For example, it allows effective control of the potential at a sufficient low value to be placed in the immunity range. Furthermore, in the case of a molten-salt nuclear reactor (MSR), such a device prevents the formation of metal actinide and in particular the formation of metal plutonium unlike metal Mg.

Furthermore, such a device is simple to prepare.

The invention also relates to a solution comprising a mixture of molten chloride salts, intended to be in contact with a wall of a component such as a primary circuit of a nuclear fission reactor, a secondary circuit of a nuclear fission reactor, a container of a concentrated solar power plant or a fluidic circuit of a concentrated solar power plant, the wall being made of steel or of a nickel-based alloy comprising chromium. The solution further comprises Ti²⁺ ions and Ti³⁺ ions, the Ti³⁺/Ti²⁺ concentration ratio being between 20/80 and 70/30.

Preferably, the mixture of molten chloride salts is a binary or ternary mixture of alkali and alkaline earth metal chlorides or a binary mixture of alkali or alkaline earth metal chlorides and of one or more actinide chlorides. The actinide chlorides are, preferably, chosen from UCl₃, PuCl₃ and AmCl₃, and more preferably from PuCl₃ and AmCl₃. The invention also relates to a method for preparing a device as defined hereinabove, the method comprising the following steps:
providing a device comprising a component configured to contain or to circulate a solution, the component having a wall made of steel or of a nickel-based alloy comprising chromium, and a solution, in contact with the wall, comprising a mixture of molten chloride salts,
immersing metal titanium in the solution, for a sufficient time to obtain Ti²⁺ ions and Ti³⁺ ions, the Ti³⁺/Ti²⁺ concentration ratio being between 20/80 and 70/30,
optionally, adding ions of a metal having a potential lower than the dissolution of chromium of the iron metal alloy in the solution, whereby the formation of Ti²⁺ ions and Ti³⁺ ions is accelerated by oxidation-reduction reactions.

The ions can be iron ions or chromium ions for example.

The invention also relates to a method for measuring the potential of a solution of a device as defined hereinabove.

Indeed, it is particularly difficult to use conventional electrodes in molten salts, such as reference electrodes of the Ag⁺/Ag⁰ type, the stability of which over time in these aggressive media is questionable. Therefore, there is a need to be able to control the potential of a molten salt solution.

According to the invention, the method for measuring the potential of a solution of a device as defined hereinabove comprises the following successive steps:
providing a device comprising a component configured to contain or to circulate a solution, the component having a wall made of steel or of a nickel-based alloy comprising chromium, and a solution, in contact with the wall, the solution comprising a mixture of molten chloride salts, Ti²⁺ ions and Ti³⁺ ions, the Ti³⁺/Ti²⁺ ratio being between 20/80 and 70/30, the mixture of molten salts comprising at least MgCl₂, and optionally PuCl₃,
immersing an anode, a cathode and a reference electrode in the solution; the anode and the cathode being made of the same material, preferably tungsten, and the reference electrode being for example made of molybdenum or preferably of tungsten,
measuring the potential E₁ between the cathode and the reference at zero or quasi-zero current (typically the potential is less than 50 mV, for example of the order of a few mV),
imposing a current between the anode and the cathode, to deposit metal magnesium on the cathode, or to deposit metal plutonium on the cathode where applicable,
measuring the potential E₂ between the cathode and the reference at zero current, whereby the value of the Mg²⁺/Mg⁰ or Pu³⁺/Pu⁰, where applicable, pair is obtained,
calculating the potential of the solution Eₛₒₗ according to Eₛₒₗ=E₂−E₁. When the value of Eₛₒₗ differs from a reference value, titanium can be added in the solution to obtain a Ti³⁺/Ti²⁺ concentration ratio between 20/80 and 70/30.

This measurement method is particularly advantageous because it makes it possible to form in situ a so-called dynamic (or transient) reference electrode and thus measure the potential of the solution reliably.

The invention also relates to a method for controlling a solution of a device as defined hereinabove, the control method comprising the following steps:
providing the device comprising the component configured to contain or to circulate the solution, the component having a wall made of steel or of a nickel-based alloy comprising chromium, and the solution, in contact with the wall, comprising a mixture of molten chloride salts, Ti²⁺ ions and Ti³⁺ ions,
removing a sample of the solution and analysing it to determine the presence or absence of iron ions and/or chromium ions,
in the event of presence of iron ions and/or chromium ions, immersing metal titanium in the solution, for a sufficient time so that the solution contains Ti²⁺ ions and Ti³⁺ ions, according to a Ti³⁺/Ti²⁺ ratio between 20/80 and 70/30.

The iron ions and/or chromium ions present in solution originate from the corrosion of the wall of the component. They are present when the concentration ratio of Ti²⁺ ions and Ti³⁺ ions is such that it no longer corresponds to the immunity range (i.e. it no longer corresponds to the potential range where redox control is effective). It is then necessary to immerse metal titanium in the solution for cathodic protection.

Advantageously, the formation of Ti²⁺ ions and Ti³⁺ ions from metal titanium is accelerated by the presence of iron ions and/or chromium ions in solution.

Other features and advantages of the invention will appear from the following complementary description.

It goes without saying that this complementary description is given solely as an illustration of the object of the invention and should, in any case, be interpreted as a limitation of this object.

### BRIEF DESCRIPTION OF THE DRAWINGS

The present invention will be better understood upon reading the description of embodiments given for purely indicative and non-limiting purposes with reference to the appended drawings, wherein:

The figure represents schematically and in a cross-section a device according to one particular embodiment of the invention.

FIG. 2 is a graph representing the voltammograms of dissolution of pure metals, according to particular embodiments of the invention.

FIG. 3 is a voltammogram of an NaCl—MgCl₂—CeCl₃ solution containing a titanium salt at 600° C., according to one particular embodiment of the invention.

FIG. 4 is a graph representing the course of the equilibrium potential of an NaCl—MgCl₂—CeCl₃ solution at 600° C. according to the immersion time of a metal titanium plate.

FIG. 5 is a graph representing the equilibrium potential of an NaCl—MgCl₂—CeCl₃ solution at 600° C. after removing a titanium plate, according to one particular embodiment of the invention.

FIG. 6 is a graph of a square wave voltammetry in an NaCl—MgCl₂—CeCl₃ solution at 600° C. containing Ti³⁺ and Ti²⁺ ions, according to one particular embodiment of the invention.

FIG. 7 represents the potential of an NaCl—MgCl₂—CeCl₃ solution at 600° C. according to the Ti³⁺ and Ti²⁺ concentration ratio, according to one particular embodiment of the invention.

FIG. 8 is an image obtained with a scanning electron microscope of a 316L steel sample after immersing in an NaCl—MgCl₂—CeCl₃ solution at 600° C. for 168h, without redox control.

FIG. 9 is an image obtained with a scanning electron microscope of a 316L steel sample after immersing in an NaCl—MgCl₂—CeCl₃ solution containing Ti³⁺ and Ti²⁺ ions having a potential of approximately −2V vs Cl₂/Cl⁻, at a temperature of 600° C. for 168h, according to one particular embodiment of the invention.

FIG. 10 is an energy dispersive X-ray (EDX) analysis carried out on a 316L steel sample after immersing in an NaCl—MgCl₂—CeCl₃ solution containing Ti³⁺ and Ti²⁺ ions having a potential of approximately −2V vs Cl₂/Cl, at a temperature of 600° C. for 168h, according to one particular embodiment of the invention.

FIG. 11 is an image obtained with a scanning electron microscope of an Inconel® 625 sample after immersing in an NaCl—MgCl₂—CeCl₃ solution containing Ti³⁺ and Ti²⁺ ions having a potential of approximately −2V vs Cl₂/Cl, at a temperature of 600° C. for 168h, according to one particular embodiment of the invention.

FIG. 12 is an energy dispersive X-ray (EDX) analysis carried out on an Inconel® 625 sample after immersing in an NaCl—MgCl₂—CeCl₃ solution containing Ti³⁺ and Ti²⁺ ions having a potential of approximately −2V vs Cl₂/Cl⁻, at a temperature of 600° C. for 168h, according to one particular embodiment of the invention.

FIG. 13 is a graph representing the potential of an NaCl—MgCl₂—CeCl₃ solution at 600° C.

FIG. 14 is a graph representing the potential of an NaCl—MgCl₂—CeCl₃ solution containing Ti³⁺ and Ti²⁺ ions at 600° C.

The different portions shown in the figures are not necessarily plotted according to a uniform scale, to make the figures more readable.

### DETAILED DISCLOSURE OF SPECIFIC EMBODIMENTS

Although this is in no way limiting, the invention finds particular applications in the nuclear or solar energy (concentrated thermal solar) field.

The invention is applicable to any device 10 comprising:
a component 20 configured to be in contact with a solution 30 and having a wall 21 made of steel or of a nickel-based alloy comprising chromium, and
a solution 30 of molten chlorides, in contact with the wall 21.

In particular, the component 20 can be used to contain the molten salt solution 30. The device 10 can be, for example, a tank, a container or an enclosure.

The component 20 can also be used to circulate the molten salt solution 30. For example, the component 20 can be a tube.

In particular, the component 20 can be a primary circuit of a nuclear fission reactor with molten-chlorides, a secondary circuit of a nuclear fission reactor comprising molten chlorides or a container of molten chlorides or a circulation circuit of molten chlorides of a concentrated solar power plant.

The component 20 has at least one wall 21. It may have several. For example, in the case of a tube, it consists of a lateral wall. In the case of a container, a tank or an enclosure, the component can comprise a lateral wall, a bottom wall (or bottom) and a top wall (or lid). Each of these walls can be in contact with the solution 30.

The material forming the wall (steel or nickel-based alloy) comprises chromium. It also comprises iron. It can also comprise one or more other elements. Without limitation, the other element(s) can be chosen from nickel, molybdenum, tungsten, silicon, cobalt, aluminium, titanium, niobium and manganese.

Chromium is the least stable element of the metal alloy, in other words, it is the most negative element. It is followed by iron, nickel and molybdenum. Tungsten is the material with the best oxidation resistance, its anodic boundary is the oxidation of chlorides to dichlorine and its cathodic limit is the reduction of Mg²⁺ to metal magnesium. There is a potential range between the reduction potential of Mg²⁺ to metal magnesium and the oxidation potential of the most negative element (i.e. here chromium) for which it is possible to limit the dissolution of steels.

According to a first alternative embodiment, the wall 21 is made of stainless steel. For example, it can consist of 316L steel.

According to another alternative embodiment, the wall 21 is made of a superalloy. For example, a nickel-chromium superalloy, and preferably a nickel-chromium-molybdenum superalloy, will be chosen. The superalloy NiCr22Mo9Nb, sold under the name Inconel® 625 by Special Metals Corporation may particularly be chosen.

The solution 30 of molten salts (also referred to as molten salt bath) is in contact with the wall 21 of the component 20.

The solution 30 comprises a mixture of molten chlorides. For example, it can consist of a binary mixture or a ternary mixture of alkali and alkaline earth metal chlorides, generally used as a heat transfer fluid, or a mixture containing actinide chlorides generally used for nuclear applications.

The molten salts to form the mixture of the first type are, preferably, chosen from LiCl, NaCl, KCl, MgCl₂, CaCl₂) and BaCl₂. For a binary mixture, it is possible to choose, for example, an NaCl—MgCl₂ mixture or a KCl—MgCl₂ mixture, whereas for a ternary mixture, it is possible to choose, for example, an NaCl—KCl—MgCl₂ mixture.

In the second case, for application in an MSR, one or more compounds having formula AcCl₃ where Ac is an actinide will be added to one of the binary mixtures described hereinabove. Preferably, Ac is Pu, Am, U or Cm. More preferably, Pu, Cm or Am will be chosen, or even more preferably Pu or Am. It is possible to choose, for example, an NaCl—MgCl₂—PuCl₃ mixture or an NaCl—MgCl₂—AmCl₃ mixture or an NaCl—MgCl₂—PuCl₃—AmCl₃ mixture.

As a chemical analogue of NaCl—MgCl₂—PuCl₃, it is possible to use the mixture NaCl—MgCl₂—CeCl₃.

The compound AcCl₃ represents, preferably, between 4.5% and 20% molar of the mixture of molten salts.

For example, a mixture of NaCl—MgCl₂—CeCl₃ (57/30/13 or 61/34/5) used as a simulant for the actinide converter (NaCl—MgCl₂—PuCl₃) may be used. The ratios are molar ratios given with respect to the solution.

The solution 30 further comprises Ti²⁺ ions and Ti³⁺ ions. The choice of the concentration ratio of the Ti²⁺ and Ti³⁺ ions is essential for protecting the material of the wall 21 in contact with the solution 30. The Ti³⁺/Ti²⁺ ratio is between 20/80 and 70/30, for example between 30/70 and 70/30 or between 20/80 and 50/50, and preferably between 30/70 and 50/50.

The potential of the solution 30 is dependent both on the Ti³⁺/Ti²⁺ ratio and the temperature according to the Nernst law (equation (1)):

$${E}_{T {i}^{3 +} + / {Ti}^{2 +}} = {E}_{T {i}^{3 +} + / {Ti}^{2 +}}^{0} + \frac{R T}{n F} ln \frac{{a}_{{TiCl}_{3}}}{{a}_{{TiCl}_{2}}} \qquad ( 1 )$$

Where:
E is the potential in Volts,
E⁰ is the standard potential of the pair in Volts,
R is the perfect gas constant,
T is the temperature in Kelvin,
n is the number of electrons exchanged,
F is the Faraday constant,
aTiCl₃ is the chemical activity of the oxidant,
aTiCl₂ is the chemical activity of the reducing agent.

Preferably, in the solution, the titanium concentration is from 0.1 to 3% molar with respect to the total concentration of the solution.

During operation of the device 10, the solution 30 is, preferably, at a temperature between 450° C. and 700° C. and preferably between 550° C. and 650° C.

For example, for a temperature of 600° C., with a Ti³⁺/Ti²⁺ ratio of 20/80, the potential of the solution 30 is approximately −2V vs Cl₂/Cl. Such a potential is sufficiently negative to prevent the dissolution of chromium observed around −1.75V vs Cl₂/Cl⁻. Such a potential also prevents the dissolution of other elements such as iron, nickel, molybdenum, for example, which have higher potentials than that of chromium.

For a temperature of 600° C., with a Ti³⁺/Ti²⁺ ratio of 50/50, the potential of the solution 30 is approximately −1.9V vs Cl₂/Cl, which is also sufficient to prevent the dissolution of the chromium present in the metal alloy of the wall.

With a ratio of 70/30, the calculated potential of the solution −1.83V vs Cl₂/Cl⁻ at 600° C., which is also sufficient to protect chromium.

Thus, for higher temperatures (for example for a temperature of 700° C.), the potentials will be higher.

It is possible to use this device 10 in the presence of an inert atmosphere (argon or helium in particular).

It is also advantageous to control the purity of the inputs associated with the tightness of the heat transfer medium circuit.

The solution 30, and in particular the mixture of molten salts, are previously purified before being used.

The method for preparing a device 10 as defined hereinabove comprises the following steps:
providing a device 10 comprising a wall 21 made of steel or of a nickel-based alloy comprising chromium, the wall 21 being in contact with a solution 30 comprising a mixture of molten chloride salts,
immersing a part made of metal titanium in the solution, for a sufficient time to obtain Ti²⁺ ions and Ti³⁺ ions, the Ti³⁺/Ti²⁺ concentration ratio being between 20/80 and 70/30,
optionally, adding in the solution ions of a metal having a potential lower than the dissolution of chromium of the metal alloy, whereby the formation of Ti²⁺ ions and Ti³⁺ ions is accelerated.

Adding metal titanium in a solution 30 comprising a mixture of molten chloride salts results in the oxidation of titanium and the formation of Ti²⁺ and Ti³⁺ ions. Indeed, for example, the solution of molten chlorides NaCl—MgCl₂—CeCl₃ or NaCl—MgCl₂—PuCl₃ in the absence of titanium has an equilibrium potential between −1.2V and −1V vs Cl₂/Cl. Thus, when titanium is added, it is oxidised and the equilibrium potential of the solution decreases until it stabilises around −2V vs Cl₂/Cl⁻ for a Ti³⁺/Ti²⁺ ratio of 20/80.

Adding ions in solution makes it possible to accelerate the formation of Ti²⁺ ions and Ti³⁺ ions via oxidation-reduction reactions. Any element having a potential less than the dissolution of chromium of the metal alloy may be used. Preferably, chromium, aluminium or zirconium can be used.

The duration for which the titanium part is immersed in the solution is dependent on several parameters, and in particular on the surface area of the immersed part of the titanium part, on the solution volume, on the stirring, on the circulation speeds, etc. A person skilled in the art will choose the duration according to the sizing of the device and how to obtain the sought Ti³⁺/Ti²⁺ ratio. For example, a sufficient duration can be a duration of 1h to 10h.

We will now describe a method for measuring the Ti³⁺/Ti²⁺ ratio in a device 10 as defined hereinabove in more detail.

The measurement method comprises the following steps:
providing a device 10 comprising a wall 21 made of steel or of a nickel-based alloy comprising chromium, the wall 21 being in contact with a solution 30 comprising a mixture of molten chloride salts, Ti²⁺ ions and Ti³⁺ ions,
carrying out square wave voltammetry in the solution to obtain reduction and oxidation curves representing the differential current according to the potential,
determining the proportion of Ti²⁺ ions and Ti³⁺ ions, by integrating the area under the reduction and oxidation curves.

Knowing the Ti³⁺/Ti²⁺ ratio, and based on the Nernst law, it is possible to calculate the potential of the solution 30. The apparent standard potential integrating the activity coefficients was evaluated at −1.89V vs Cl/Cl₂.

This measurement method is particularly advantageous because, based on the shape of the curves, it is possible to determine quickly and simply the scenario in question. Indeed, when the oxidation curve shows an almost complete Gaussian, the Ti²⁺ content is largely greater than 50%. At a 50/50 ratio, the oxidation curve starts at the peak and only shows the right part of the Gaussian. The same applies for the part in reduction.

We will now describe a method for measuring the potential of a solution 30 of molten salts.

The measurement method comprises the following successive steps:
a) immersing an anode, a cathode and a reference electrode in the solution 30 comprising a mixture of molten chloride salts, and optionally Ti²⁺ ions and Ti³⁺ ions, the mixture of molten salts comprising at least MgCl₂,
b) measuring the potential E₁ between the cathode and the reference at zero or quasi-zero current,
c) imposing a current between the anode and the cathode, to deposit metal magnesium on the cathode,
d) measuring the potential E₂ between the reference and the cathode at zero current, whereby the value of the Mg²⁺/Mg⁰ pair is obtained,
e) calculating the potential of the solution Eₛₒₗ according to Eₛₒₗ=E₂−E₁.

The electrodes are, advantageously, made of the same material not oxidised in the solution. The electrodes (anodes and cathodes) are, advantageously, made of tungsten.

The reference electrode is, advantageously, a metal wire which does not oxidise in the solution: the electrode is referred to as dynamic electrode or transient electrode. Preferably, a reference electrode made of molybdenum or more preferably an electrode made of tungsten will be chosen.

During step b), the potential between the cathode and the reference is measured in the solution 30 at zero current. The potential is quasi-zero (typically less than 50 mV, in particular less than 5 mV) because the electrodes are made of the same metal conductor.

Before step c), it is also possible to measure the potential between the anode and the reference at zero current. The potential will also be quasi-zero.

During step c), a constant current pulse is applied, for example for a duration between 5 s and 20 s, for example 10s. During this step, the potential of the cathode is fixed on that of the reduction of Mg²⁺ to metal magnesium, whereas that of the anode evolves towards the oxidation potential of the chlorides to gaseous dichloride. Preferably, the ratio of the anode/cathode surface areas is between 1 and 3, ideally 2, and J_{Cat} is between 0.05 A/cm² and 0.8 A/cm².

During step d), the potentials of the anode and of the cathode are measured in the solution 30 at zero current with respect to the reference. The potential of the cathode temporarily takes the value of the Mg²⁺/Mg⁰ electrochemical pair.

The potential of the cathode after the pulse is not dependent on the current applied. According to the Nernst law, it is only dependent on the Mg²⁺ concentration. However, due to the high concentration of Mg²⁺ in the solution (logarithmic term), the cathode potential is also little dependent on variations of the Mg²⁺ concentration.

The time during which the potential of the Mg²⁺/Mg⁰ pair can be observed is dependent on the current applied: the higher the current, the greater the quantity of metal Mg deposited and the longer the potential of the Mg²⁺/Mg⁰ pair can be used as a reference value.

During step e), the potential of the solution 30 is obtained by comparing the values of the potentials between step b) and step d) when magnesium is still present on the cathode.

In the case of a ternary mixture of molten salts comprising PuCl₃, plutonium will be formed instead of magnesium. In step c), metal plutonium will be deposited on the cathode and in step d), the value of the Pu³⁺/Pu⁰ pair is obtained.

### Illustrative and Non-Limiting Examples of an Embodiment

Study of the anodic dissolution of chromium, iron and nickel:

The anodic dissolution of chromium, of iron and of nickel was firstly studied in an NaCl—MgCl₂—CeCl₃ (57/30/13) solution at 600° C. This salt was used as a simulant for the actinide converter (NaCl—MgCl₂—PuCl₃).

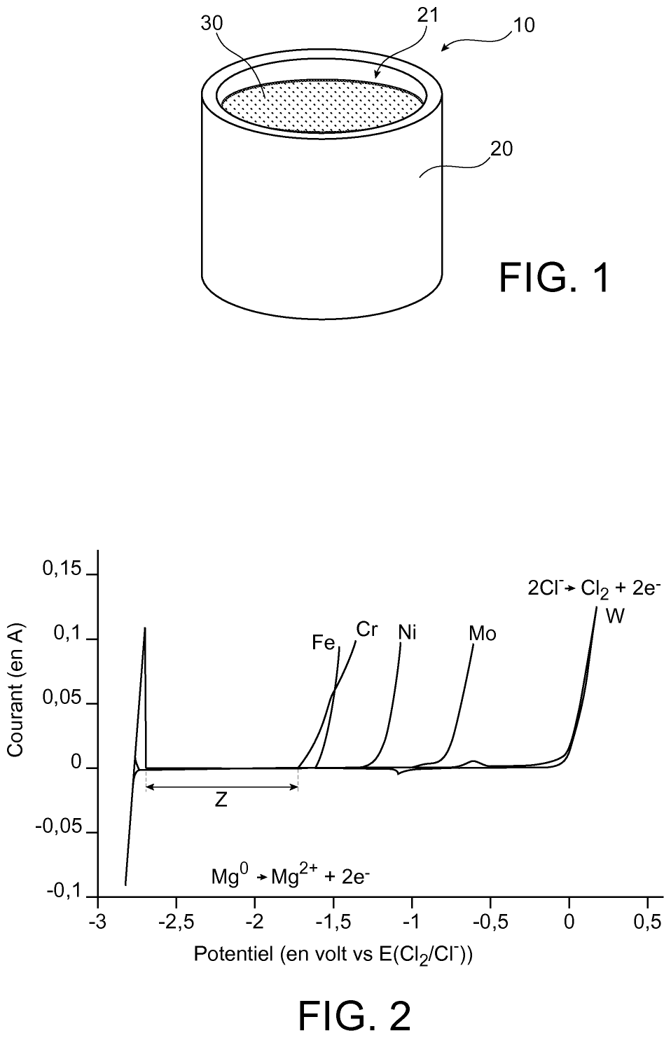

The voltammograms obtained for these metals are shown in FIG. 2. Several observations can be made by comparing the intensity-potential plots obtained with the different metals:
tungsten is the material with the best oxidation resistance, its anodic boundary is the oxidation of chlorides to dichlorine and its cathodic limit is the reduction of Mg²⁺ to metal magnesium,
the potentials of dissolution of chromium, of iron and of nickel confirm that chromium is the least stable element (most negative potential) followed by iron and by nickel, which is consistent with the sequence predicted by the thermodynamics of the pure substances,
there is a wide potential range (annotated Z in FIG. 2) between −1.75 and −2.75 V vs E (Cl₂/Cl⁻) where an effective redox control can be performed to limit steel dissolution.

Therefore, the difficulty is not only that of being able to obtain this potential range in a highly corrosive solution and generally operating at high temperature (typically greater than 450° C., or even greater than 550° C. and even more preferably between 600° C. and 700° C.), but also that of being able to control and to maintain it.

Study of the Ti³⁺/Ti²⁺ Buffer Electrochemical Pair:

Titanium was studied in a solution of molten salts NaCl—MgCl₂—CeCl₃ at 600° C.

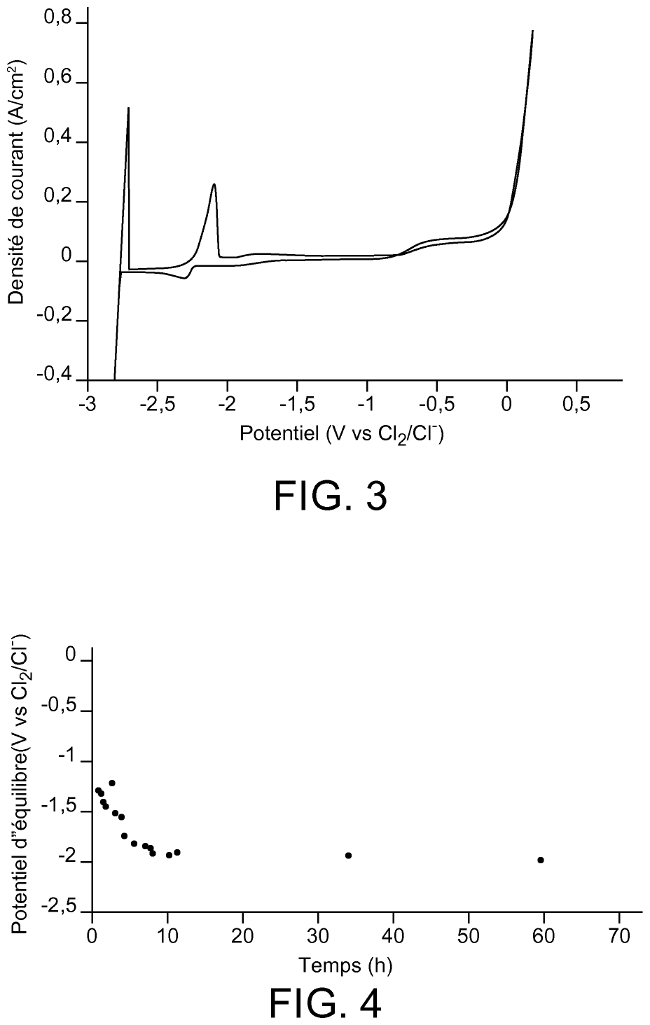

Titanium can, depending on the potential of the solution, be metal, or dissolved in the salt in the form of divalent, trivalent and tetravalent complexes (FIG. 3). The wave observed before the wall of dichloride corresponds to the oxidation of Ti³⁺ to Ti⁴⁺. The reduction wave around −1.6 V corresponds to the reduction of Ti³⁺ to Ti²⁺.

The reduction peak of Ti²⁺ to metal titanium is observed around −2.35 V, it is associated with its fine oxidation peak, which is characteristic of the dissolution of the electrodeposited metal.

The equilibrium potential of a solution of molten alkali and alkaline earth chlorides in the absence of titanium is situated between −1 and −1.2 V.

In the presence of metal Ti, Ti³⁺ is reduced to Ti²⁺.

The Ti³⁺ and Ti²⁺ ions are stable and coexist then in the solution according to the equilibrium:

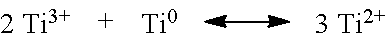

In this case, the potential control is ensured by the Ti³⁺/Ti²⁺ pair.

The presence of metal titanium results in the decrease of the potential of the solution to stable value situated around −2 V (FIG. 4).

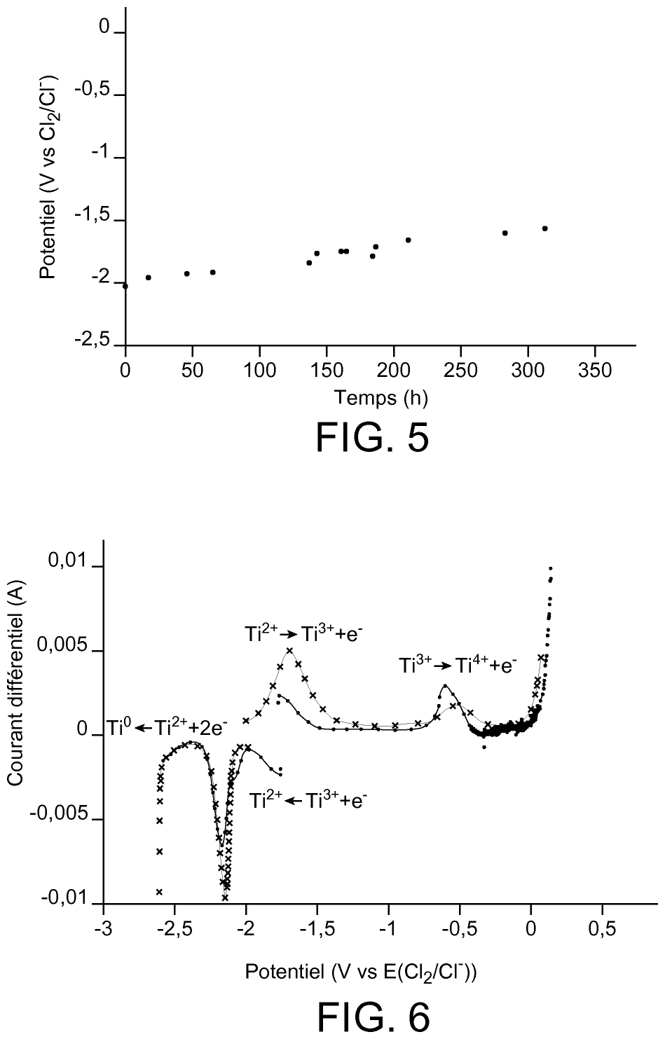

Once the reduction of Ti³⁺ to Ti²⁺ has been obtained, the metal plate of titanium is removed from the solution and the equilibrium potential of the solution is measured as a function of time: it rises very slowly and linearly until it reaches its original value before the reduction phase after several hundred hours (FIG. 5).

The Nernst law was then verified using the square wave voltammetry (SWV) technique to determine the proportions of Ti³⁺ and Ti²⁺ as a function of time in the molten salt solution. The proportion of the two species is estimated by integrating the areas under the curves of reduction of Ti³⁺ to Ti²⁺ and of oxidation of Ti²⁺ to Ti³⁺ measured regularly over time after removing the titanium plate (FIG. 6). The curve with the crosses in FIG. 6 represents a solution where titanium is present at more than 90% in the Ti²⁺ form, whereas the other curve shows a 50/50% mixture of Ti²⁺ and Ti³⁺.

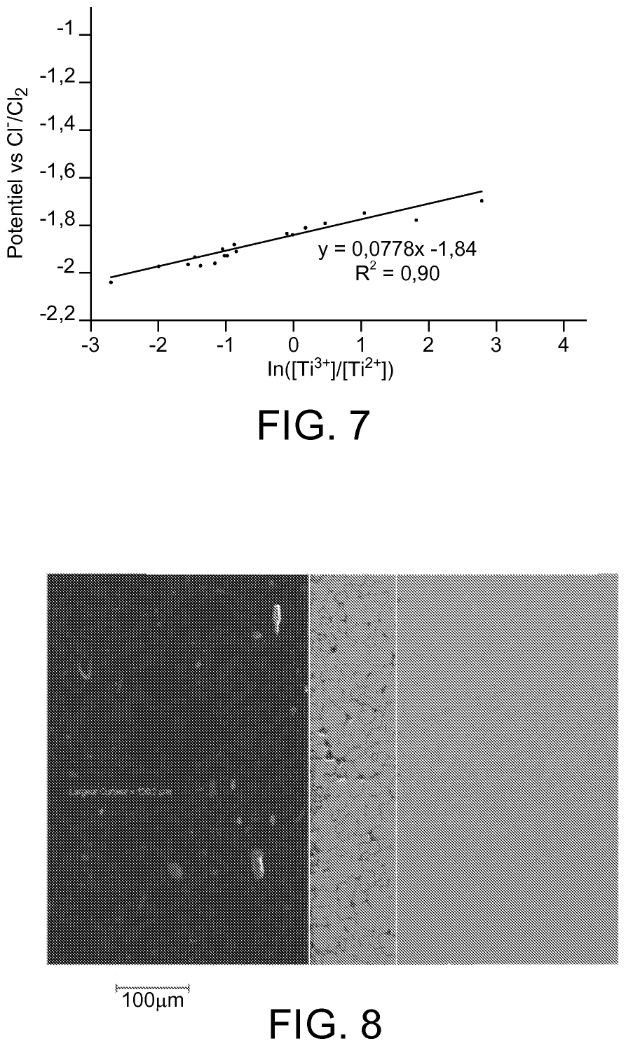

The evolution of the potential according to the logarithm of the ratio of the Ti³⁺ and Ti²⁺ concentration obtained by SWV is linear according to the Nernst law (FIG. 7). The experimental slope (RT/nF) is 0.078, i.e. an electron number of 0.97 indeed corresponding to the Ti³⁺/Ti²⁺ electron transition. Verification of the Nernst law makes it possible to conclude that the potential of the solution is indeed controlled by the joint presence in the solution of molten salts of divalent and trivalent titanium.

The most negative potential corresponds to a Ti³⁺/Ti²⁺ ratio of 20%/80%, the highest potential a ratio of 70%/30%.

Immersion of 316L Steel in NaCl—MgCl₂—CeCl₃ without Redox Control for One Week:

A 316L steel plate was immersed in NaCl—MgCl₂—CeCl₃ without redox control of the potential of the solution for one week (i.e. 168 hours) at 600° C. The plate is held in the solution by a molybdenum wire, the molybdenum-material contact is maintained outside the molten salt. The tests are carried out in an inerted glove box under argon, the molten salt is in an alumina crucible, itself placed inside a sealed quartz cell scavenged with high-purity argon (Alphagaz2).

After immersion for one week, the immersed part of the sample is cut into sections and analysed by SEM-EDX (FIG. 8). The section analysis shows a conventional corrosion profile in these media:
Intergranular corrosion,
Corroded depth of approximately 100 μm,
Beyond this depth, the mass composition of 316 steel is detected.

The corresponding EDX analysis confirms Cr and Fe loss.

Immersion of Inconel 625® in NaCl—MgCl₂—CeCl₃ without redox control for one week:

An Inconel 625® plate was immersed in NaCl—MgCl₂—CeCl₃ without redox control of the potential of the solution for one week (i.e. 168 hours) at 600° C. as in the preceding example with 316L steel.

After immersion for one week, the immersed part of the sample is cut into sections and analysed by SEM-EDX. On the sample, six different sites were observed. All show a uniform corrosion over a depth between 2 and 5 μm. Inconel 625 offers a much greater corrosion resistance than 316 steel.

The EDX analysis of the immersed and corroded part shows chromium loss and surface enrichment with Ni and Mo.

Immersion of Inconel 625® in NaCl—MgCl₂—CeCl₃ without Redox Control for Three Weeks:

An Inconel 625® plate was immersed in NaCl—MgCl₂—CeCl₃ without redox control of the potential of the solution for three weeks (i.e. 504 hours) at 600° C.

After immersion for three weeks, the immersed part of the sample is cut into sections and analysed by SEM-EDX. Uniform corrosion of a thickness of approximately 8 μm is observed, confirming that the corroded thickness increases between 1 and 3 weeks of immersion. The EDX analysis of the immersed and corroded part confirms that there is chromium loss and surface enrichment with Ni and Mo.

Immersion of 316L Steel and Inconel 625° in NaCl—MgCl₂—CeCl₃ with Redox Control by the Ti³⁺/Ti²⁺ Pair for One Week:

316L Steel and Inconel 625® plates were immersed in NaCl—MgCl₂—CeCl₃ containing the Ti³⁺/Ti²⁺ pair at 600° C. for one week (168 hours) and one month (720 hours). The potential of the solution was previously adjusted by immersing a metal titanium plate in order to obtain titanium in solution mostly in Ti²⁺ form (˜80% Ti²⁺ and 20% Ti³⁺). The potential obtained of approximately −2 V vs Cl₂/Cl⁻) is sufficiently negative to prevent the dissolution of chromium observed around −1.75V vs Cl₂/Cl.

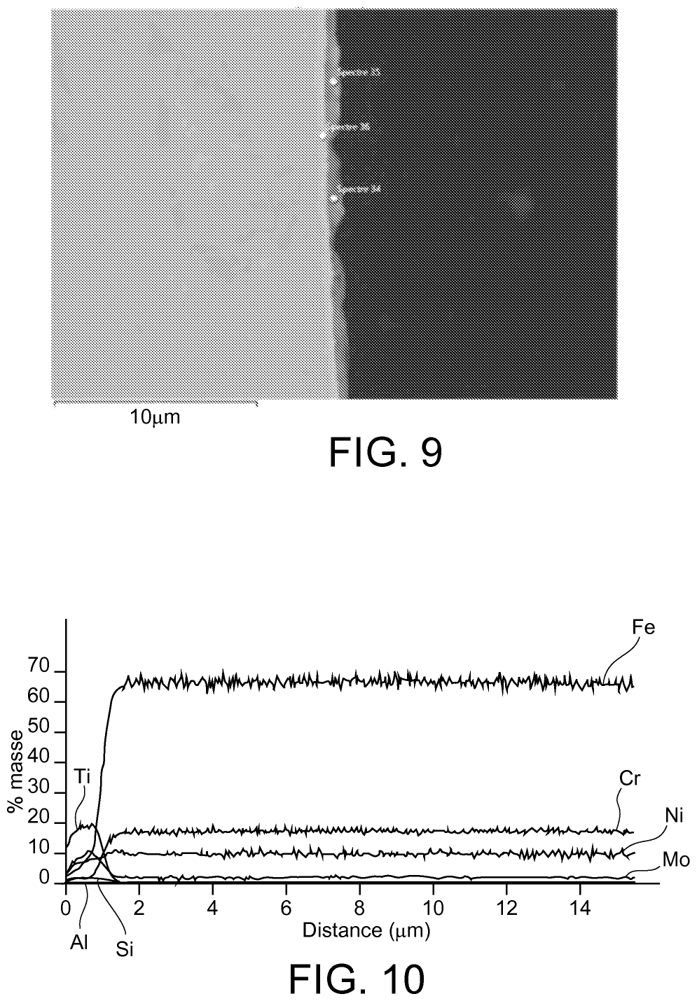

The SEM image of the 316L sample after immersion for 168h with redox control shows that the 316L steel was protected during this test (FIG. 9). The presence of deposits is observed on the sample surface.

The EDX analysis indicates an attack of the material over 1 to 2 μm at the molten salt/metal interface (FIG. 10). This layer is rich in Ti. Molybdenum is also found, most probably coming from a contamination of the measurement electrodes.

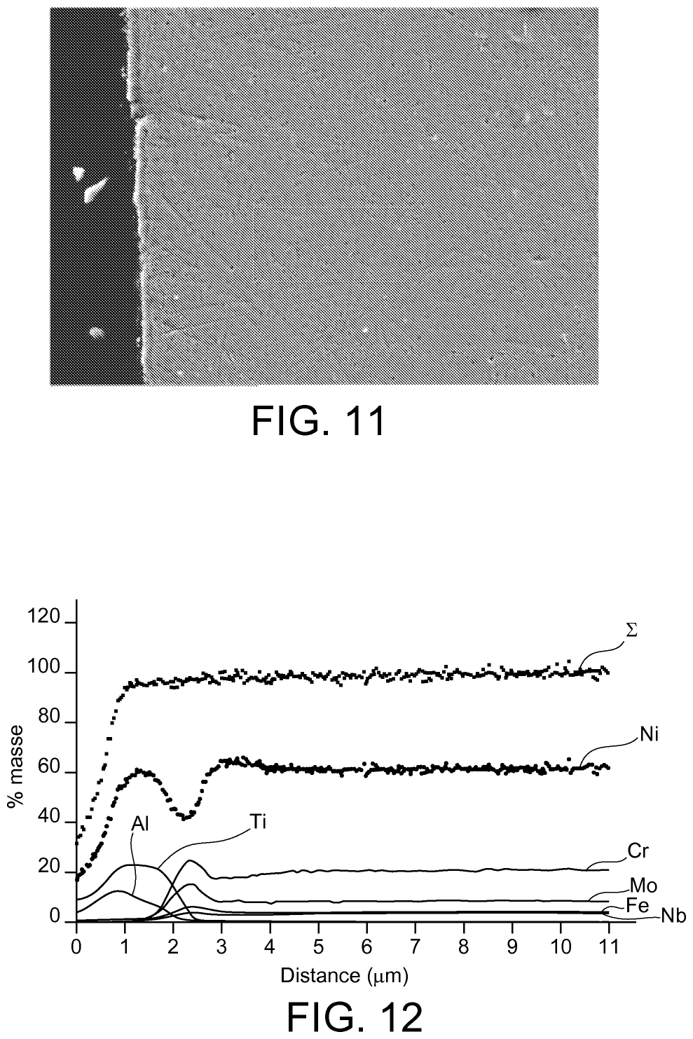

The observations of the Inconel® 625 sample after immersion are similar to those made for the 316L steel. The coupon has little or no corrosion (FIG. 11).

The EDX analysis (FIG. 12) also shows a deposit of titanium and of aluminium (pollution from the alumina crucible) alloyed with nickel. The thickness of the layer is slightly greater (˜3-4 μm) than that observed on the 316 steel (˜2 μm).

Under the reducing conditions imposed by the Ti³⁺/Ti²⁺ redox buffer, the deposition of metals on the surface seems to be facilitated with Inconel®. Indeed, as this material is richer in nickel, it can form numerous alloys in these temperature ranges.

Immersion of 316L and Inconel 625® in NaCl—MgCl₂—CeCl₃ with Redox Control by the Ti³⁺/Ti²⁺ Pair for One Month (720 h):

A 316L steel plate was immersed at 600° C. for one month. The sample was cut up in order to be able to characterise an immersed part and a part positioned above the salt. As above, the sample has little corrosion. A thin layer of Ti at the outer periphery of the sample can be observed. The comparison of the immersed and non-immersed parts of the sample does not show more accentuated corrosion in the immersed part and makes it possible to rule out uniform corrosion of the sample in the part in contact with the solution.

The EDX analysis of the periphery of the sample confirms that, as hereinabove, the sample is corroded over ˜2 μm with loss of chromium, iron and nickel and enrichment in titanium. This corrosion thickness, identical for immersions of one week and of one month, seems to show that the corrosion layer does not increase over time.

After immersing the Inconel® 625 plate at 600° C. for one month, the sample is relatively non-corroded and a layer of Ti alloyed with nickel in the Inconel® 625 samples is formed at the periphery of the sample. The thickness of the corrosion layer is approximately 3 μm as in the one-week test, which tends to show that the corrosion does not progress much over time, as for the 316 steel.

### Measurement of the Potential of the Solution:

Corrosion control based on the use of a suitable buffer pair is effective but requires having a method for measuring the chemical potential of the solution. An electrochemical technique has been developed to monitor the chemical potential of the solution. It is based on the principle of a so-called dynamic reference electrode. The method consists of creating, with a current pulse, a metal deposition on an inert electrical conductor (tungsten or molybdenum for example). In a salt containing a large proportion of MgCl₂ such as NaCl—MgCl₂, KCl—MgCl₂, NaCl—KCl—MgCl₂, the current flow results in the production of metal magnesium on the cathode. When the current is stopped, the potential of the cathode takes that of the Nernst law for the Mg²⁺/Mg⁰ pair and then forms a reference electrode generated in situ in the saline medium. The value of the potential of this reference electrode is stable for a sufficient time to serve as a reference electrode, the value is also particularly reproducible on account of the high MgCl₂ content.

To carry out the measurement, a three-electrode set-up is used. The cathode and the anode are made of tungsten and the quasi-reference electrode is made of molybdenum or preferably of tungsten.

The method comprises three separate phases:
phase 1: Measuring the potential at zero current between the two electrodes (anode vs reference and cathode vs reference),
phase 2: Imposing a current over a brief period (<10 s)
phase 3: Measuring the potential at zero current between the two electrodes (anode vs reference and cathode vs reference).

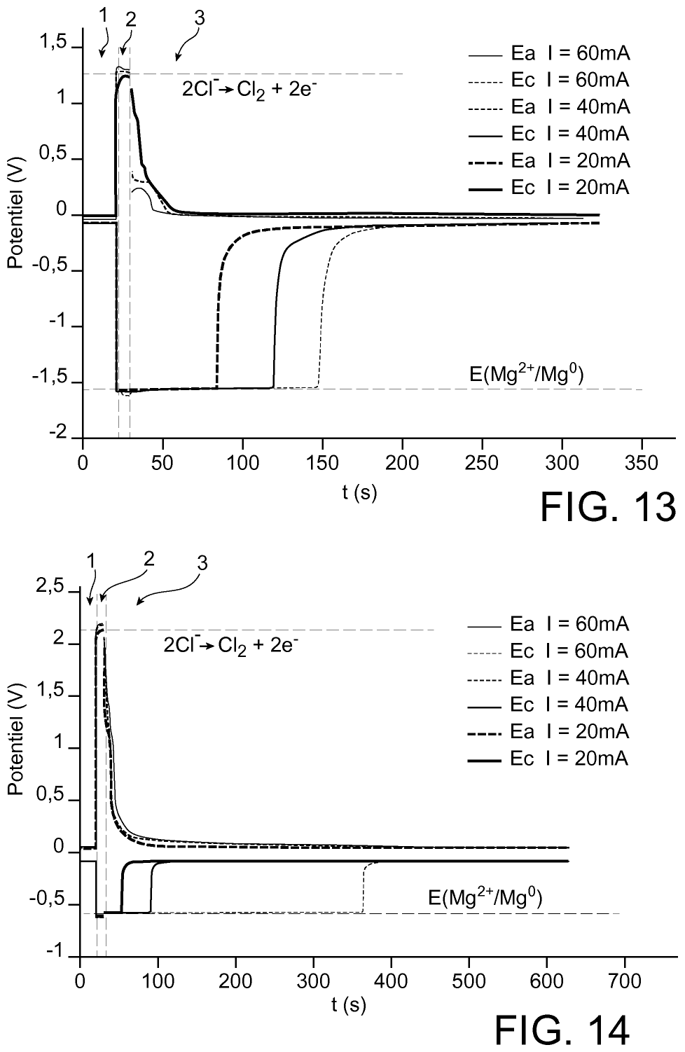

These three phases are illustrated in FIG. 13. The solution used is an NaCl—MgCl₂—CeCl₃ solution at 600° C. Ea represents the anodic potential and Ec represents the cathodic potential. During phase 1 (annotated 1 in the graph), the potentials of the anode and of the cathode are measured at zero current with respect to the reference, the values are close to zero (<50 mV). During phase 2 (annotated 2 in the graph), a constant current pulse of 10s is applied, the potential of the cathode is fixed on that of the reduction of Mg²⁺ to metal magnesium, whereas that of the anode will be fixed at the oxidation of the chlorides to gaseous dichloride. Several currents (20 mA, 40 mA and 60 mA) were tested. During phase 3 (annotated 3 in the graph), the potentials of the anode and of the cathode are measured at zero current. The potential of the cathode temporarily takes the value of the Mg²⁺/Mg⁰ electrochemical pair before returning to its original value. The potential of the anode after stopping the current rapidly returns to its initial potential.

The potential of the cathode after the pulse is not dependent on the current applied as shown in FIG. 13, it is only dependent according to the Nernst law on the Mg²⁺ concentration, it also has little dependence on Mg²⁺ concentration variations due to its high concentration in the solution (logarithmic term). The time during which the potential of the Mg²⁺/Mg⁰ pair can be observed is dependent on the current applied, the higher the current, the greater the quantity of metal Mg deposited and the longer the potential of the Mg²⁺/Mg⁰ pair can be used as a reference value.

The measurement of the potential of the solution is obtained by comparing the values of the potentials between phase 1 (close to 0) and phase 2 (when the Mg²⁺/Mg⁰ pair is stable). In the scenario shown in FIG. 13, the measurement of the potential is approximately −1.5 V, this indicates that the potential of the tungsten electrode in the molten salt is 1.5 V greater than that of the Mg²⁺/Mg⁰ dynamic reference electrode.

This method was repeated in an NaCl—MgCl₂—CeCl₃ solution comprising the Ti³⁺/Ti²⁺ buffer pair at 600° C. (FIG. 14). The characteristics of the curves obtained are identical to those of FIG. 13, the major difference lies in the value of the measurement of the potential of the solution of molten salts: the potential of the molten salts containing titanium is only approximately 0.5 V greater than that of the Mg²⁺/Mg⁰ dynamic electrode. The presence of titanium in the solution therefore lowers its potential by approximately 1 V thus making it possible to bring the potential of the solution and therefore of the electrically conductive materials contained therein within an immunity range which limits the corrosion of the metals substantially.

The oxidising characteristic of baths of molten salt tends to convert over time the reduced species of the Ti²⁺ redox buffer pair to Ti³⁺. Hence, the potential of the salt according to the Nernst law tends to increase over time. The proposed measurement makes it possible to detect this increase in potential. The potential of the solution can be lowered in a few hours by immersing metal titanium in the solution in order to convert Ti³⁺ to Ti²⁺.

What is claimed is:

1. A device comprising:
a component configured to contain or to circulate a solution, the component having a wall made of steel or of a nickel-based alloy comprising chromium,
a solution, in contact with the wall, comprising a mixture of salts of molten chlorides, wherein the solution further comprises Ti²⁺ ions and Ti³⁺ ions, the Ti³⁺/Ti²⁺ concentration ratio being between 20/80 and 70/30.

2. The device according to claim 1, wherein the molten chloride salt mixture is a binary or ternary mixture of alkali and alkaline earth metal chlorides or a binary mixture of alkali or alkaline earth metal chlorides and of one or more actinide chlorides.

3. The device according to claim 1, wherein the component is a primary circuit of a nuclear fission reactor or a secondary circuit of a nuclear fission reactor.

4. The device according to claim 1, wherein the component is a container or a fluidic circuit of a concentrated solar power plant.

5. The device according to claim 1, wherein the component is a secondary circuit of a nuclear fission reactor, a container or a fluidic circuit of a concentrated solar power plant and in that the mixture of molten chloride salts is a binary or ternary mixture obtained from molten chlorides chosen from LiCl, NaCl, KCl, MgCl₂, CaCl₂ and BaCl₂.

6. The device according to claim 5, wherein the mixture of molten chloride salts is an NaCl—MgCl₂, KCl—MgCl₂ or NaCl—KCl—MgCl₂ mixture.

7. The device according to claim 3, wherein the component is a primary circuit of a nuclear fission reactor and wherein the mixture of molten chloride salts comprises at least one actinide chloride.

8. The device according to claim 7, wherein the mixture of molten chloride salts is an NaCl—MgCl₂—PuCl₃ or NaCl—MgCl₂—PuCl₃—AmCl₃ mixture.

9. The device according to claim 1, wherein the solution is at a temperature between 450° C. and 700° C. and preferably between 550° C. and 650° C.

10. The device according to claim 1, wherein the wall is made of stainless steel, for example of 316L steel, or of a nickel-chromium-molybdenum alloy, for example NiCr22Mo9Nb.

11. The device according to claim 1, wherein the Ti³⁺/Ti²⁺ ratio is between 30/70 and 50/50.

12. A solution comprising a mixture of molten chloride salts, configured to be in contact with a wall of a component such as a primary circuit of a nuclear fission reactor, a secondary circuit of a nuclear fission reactor, a container of a concentrated solar power plant or a fluidic circuit of a concentrated solar power plant, the wall being made of steel or of a nickel-based alloy comprising chromium,
wherein the solution further comprises Ti²⁺ ions and Ti³⁺ ions, the Ti³⁺/Ti²⁺ concentration ratio being between 20/80 and 70/30.

13. The solution according to claim 12, wherein the molten chloride salt mixture is a binary or ternary mixture of alkali and alkaline earth metal chlorides or a binary mixture of alkali or alkaline earth metal chlorides and of one or more actinide chlorides.

14. A method for preparing a device as defined in claim 1, comprising the following steps:
providing a device comprising a component configured to contain or to circulate a solution, the component having a wall made of steel or of a nickel-based alloy comprising chromium, and a solution, in contact with the wall, comprising a mixture of molten chloride salts,
immersing metal titanium in the solution, for a sufficient time to obtain Ti²⁺ ions and Ti³⁺ ions, the Ti³⁺/Ti²⁺ concentration ratio being between 20/80 and 70/30,
optionally, adding in the solution ions of a metal having a lower potential than the dissolution of chromium of the metal alloy, whereby the formation of Ti²⁺ ions and Ti³⁺ ions is accelerated.

15. A method for measuring the potential of a solution of a device as defined in claim 1, the measurement method comprising the following successive steps:
providing a device comprising a component configured to contain or to circulate a solution, the component having a wall made of steel or of a nickel-based alloy comprising chromium, and a solution, in contact with the wall, the solution comprising a mixture of molten chloride salts, Ti²⁺ ions and Ti³⁺ ions, the Ti³⁺/Ti²⁺ ratio being between 20/80 and 70/30, the molten salt mixture comprising at least MgCl₂, and optionally PuCl₃,
immersing an anode, a cathode and a reference electrode in the solution, the anode, the cathode and the reference electrode being made of the same material, advantageously tungsten,
measuring the potential E₁ between the cathode and the reference at zero or quasi-zero current,
imposing a current between the anode and the cathode, to deposit metal magnesium on the cathode, or to deposit metal plutonium on the cathode where applicable,
measuring the potential E₂ between the cathode and the reference at zero current, whereby the value of the Mg²⁺/Mg⁰ or Pu³⁺/Pu⁰, where applicable, pair is obtained,
calculating the potential of the solution Eₛₒₗ according to Eₛₒₗ=E₂−E₁.

16. A method for controlling a solution of a device as defined in claim 1, the control method comprising the following successive steps:
providing the device comprising the component configured to contain or to circulate the solution, the component having a wall made of steel or of a nickel-based alloy comprising chromium, and the solution, in contact with the wall, comprising a mixture of molten chloride salts, Ti²⁺ ions and Ti³⁺ ions,
removing a sample of the solution and analysing it to determine the presence or absence of iron ions and/or chromium ions,
in the event of presence of iron ions and/or chromium ions, immersing metal titanium in the solution, for a sufficient time so that the solution contains Ti²⁺ ions and Ti³⁺ ions, according to a Ti³⁺/Ti²⁺ ratio between 20/80 and 70/30.
